(19) United States
(12) Patent Application Publication
(10) Pub. No.: US 2008/0146184 A1
(43) Pub. Date: Jun. 19, 2008

(54) SUPPRESSION OF LO-RELATED INTERFERENCE FROM TUNERS

(75) Inventor: David Dessert, Wylie, TX (US)

Correspondence Address: FULBRIGHT & JAWORSKI L.L.P, 2200 ROSS AVENUE, SUITE 2800, DALLAS, TX, 75201-2784, US

(73) Assignee: Microtune (Texas), L.P., Plano, TX (US)

(21) Appl. No.: 11/613,079

(22) Filed: Dec. 19, 2006

(51) Int. Cl. H04B 1/10

(52) U.S. Cl. 455/310

(57) ABSTRACT

A system for processing a signal comprises a tuner with a signal path that includes two or more mixers each of the mixers controlled by a respective local oscillator (LO); an analog-to-digital converter (ADC) in the signal path operable to produce a digital signal, wherein each of the local oscillators and the ADC are driven by clock signals; and a filter unit adapted to apply a notch filter to one or more spurious signals in the digital signal, wherein the notch filter is based at least in part on frequency multiplication factors in each of the clock signals.

### CROSS-REFERENCE TO RELATED APPLICATIONS

The present invention is related to co-pending and commonly assigned U.S. patent applications Ser. No. 10/952,185 entitled “SYSTEM AND METHOD OF ELIMINATING OR MINIMIZING LO-RELATED INTERFERENCE FROM TUNERS,” filed Sep. 28, 2004, and Ser. No. 11/325,854 entitled “SYSTEM AND METHOD FOR DISCOVERING FREQUENCY-RELATED SPURS IN A MULTI-CONVERSION TUNER,” filed Jan. 5, 2006 the disclosures of which are hereby incorporated herein by reference in their entirety.

### TECHNICAL FIELD

The present description is related, in general, to signal tuners, and, more specifically, to suppressing spurious signals therein.

### BACKGROUND OF THE INVENTION

Signal tuners generally receive an input Radio Frequency (RK) signal, filter the signal in an RF filter, then mix the output to create an Intermediate Frequency (IF) signal that is passed to demodulation circuitry. Multiple-conversion tuners use multiple mixers to generate the IF signal. One example is a double-conversion tuner with two mixers. In a typical double-conversion tuner, an incoming signal at frequency, ƒ_{IN} is mixed with a signal at frequency ƒ_{LO1} from a first local oscillator (LO) to produce a first signal at an intermediate frequency ƒ_{IF}. This signal is then mixed with a signal at frequency ƒ_{LO2} from a second local oscillator signal to produce the IF signal with a desired output frequency ƒ_{OUT}.

Typical multiple-conversion tuners produce spurious signals (spurs) in the IF signal due to the LOs. Specifically, such spurs are referred to as “LO-related spurs” to differentiate them from spurs caused by other phenomena. LO-related spurs occur at frequencies that correspond to mixed harmonics of the LOs. For example, a typical spur in a double conversion tuner may be found at, e.g., a frequency of two times the first LO frequency minus three times the second LO frequency.

One reason why it is important to avoid LO-related spurs is that a spur which is generated by multiples ƒ_{LO1} and ƒ_{LO2} in a double-conversion system can have a power level which is much greater than the actual RF signal of interest. Therefore, if an LO-related spur falls in the desired IF output pass band, its amplitude (power level) may be larger than the IF output level of the original desired signal, corrupting the performance of the tuner.

One of the fixes for this problem is that when it is known that a certain LO-related spur will fall within the output pass band, the LO frequencies can be changed (up or down) a certain amount, which will, in effect, still allow the circuit to tune to the desired output frequency, and the spur will be moved up or down and outside of the output bandwidth of the tuner.

Even so, avoidance of these LO-related spurs may not always be possible due to their number (especially in multi-tuner configurations and/or configurations with large output pass bands). Currently there is no solution available that allows LO-related spurs to be suppressed or removed from signals with greater reliability than the avoidance technique described above while minimally affecting the signal itself.

### BRIEF SUMMARY OF THE INVENTION

Various embodiments of the present invention are directed to systems and methods for suppressing LO-related spurs in multiple-conversion tuner systems using precisely-calculated notch filters. The notch filters can be calculated, at least in part, on known relationships between the LO-related spurs and frequency multiplication factors associated with each of the LOs and any analog-to-digital converters (ADCs).

In an example embodiment, a tuner system includes multiple (two or more) mixers, each of which are controlled by a respective LO. The example embodiment also includes an ADC, and the ADC and respective LOs are driven by clock signals that are based on the same crystal frequency. Since the frequencies that drive the LOs and the ADC are known, the frequencies of any LO-related spurs in an output band of interest can be calculated. In this particular example, the internally-generated spurs are based on the common crystal frequency and can be calculated precisely. The IF signal output from the last mixer is sent to the ADC, which digitizes the IF signal. Following the ADC is a frequency-domain conversion unit that performs, e.g., an FFT operation of size N. Each of the N output terms (“bins”) of the FFT corresponds to the magnitude of the digitized IF signal at a certain frequency. The bin numbers of the LO-related spurs in the output band of interest are calculated, allowing a notch filter to suppress those bins while leaving the other bins untouched.

In many embodiments, a spur does not fall exactly in a single bin, but rather, more often falls between two bins. In such a case the system can apply a notch filter to suppress the two bins.

In the embodiment described above, the respective clocks are based on the same crystal frequency. Such a configuration may be readily adapted for use in embodiments wherein the tuner and ADC are disposed, at least in part, on a same semiconductor chip. However, such configuration is not a requirement. In fact, in some embodiments, the respective clock signals are not all based on a common clock. In such cases, a control unit may measure the differences in each of the respective clock signals and calculate multiplication constant relationships therebetween. This allows the system to calculate where the spurs of interest will be located after the time-domain conversion.

An advantage of some embodiments is that a notch filter can be generated to be quite narrow so that it suppresses only those bins that contain spurs of interest, leaving adjacent bins substantially unaffected. Minimal suppression filtering can allow much or all of the signal information to be restored through error correction logic.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present inventions reference is now made to the following descriptions taken in conjunction with the accompanying drawings, in which:

FIG. 1 is an illustration of an exemplary system adapted according to one embodiment of the invention;

FIG. 2 is an illustration of an exemplary system adapted according to one embodiment of the invention;

FIG. 3 is an illustration of an exemplary system adapted according to one embodiment of the invention; and

FIG. 4 is an illustration of an exemplary method adapted according to one embodiment of the present invention.

### DETAILED DESCRIPTION OF THE INVENTION

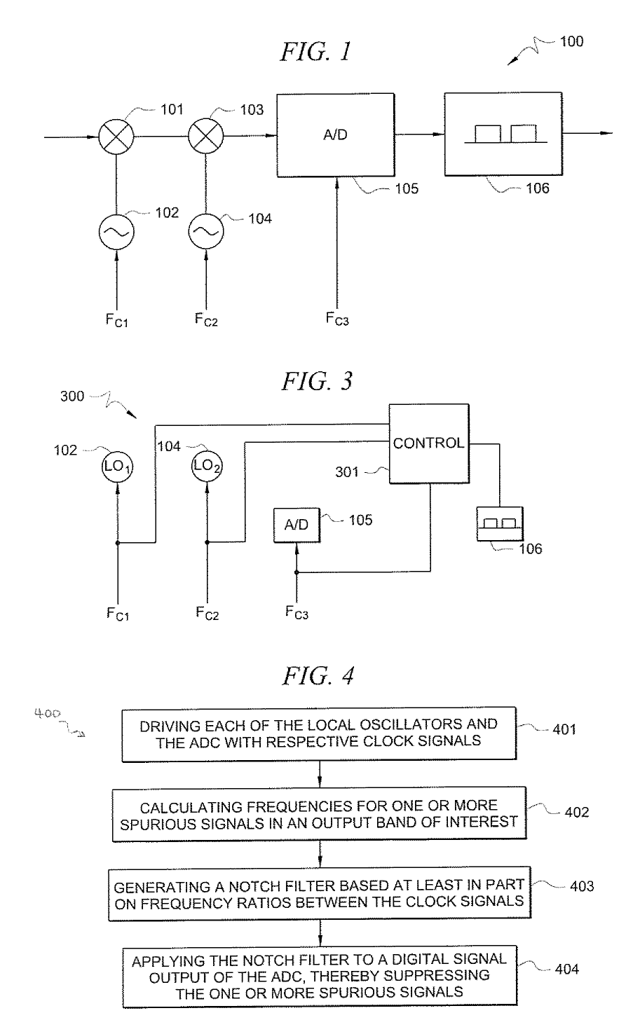

FIG. 1 is an illustration of exemplary system 100 adapted according to one embodiment of the invention. System 100 is a system for tuning a signal, and it includes mixers 101 and 103 that are controlled by local oscillators 102 and 104. (Embodiments of the invention can be adapted for use in any multiple conversion tuner, another example of which is illustrated in U.S. Pat. No. 6,177,964, the disclosure of which is hereby incorporated herein by reference.) Mixer 101 receives a signal from, e.g., a Radio Frequency (RF) filter. Mixer 103 outputs, e.g, an Intermediate Frequency (IF) signal. Local oscillators (LOs) 102 and 104 receive clock frequency signals f_{c1} and f_{c2}, respectively. Signal tuners with two or more mixers generally experience spurious signals (“spurs”) that are based, at least in part, on the frequencies of the LOs feeding those mixers. In fact, the spurious signals are usually derivable from various harmonics of the LO frequencies, as explained further below. In this example, such spurious signals are found in the output signal of mixer 103.

Analog-to-digital converter (ADC) 105 is also in the signal path and receives the IF signal output from mixer 103. ADC 105, as its name implies, converts the signal into a digital signal. ADC 105 is driven by clock frequency signal f_{c3}. The digital signal is sent to filter unit 106 that applies a digital notch filter to the signal to suppress unwanted spurs. In this example, the notch filter is calculated based, at least in part, on frequency multipliers present in each of f_{c1}, f_{c2}, and f_{c3} (or, more specifically, on weighted frequency ratios between each of f_{c1}, f_{c2}, and f_{c3}, as shown by equations (2) and (3), below).

While system 100 is shown with two mixers, various embodiments of the invention are not so limited. The principles herein may be adapted for a tuner system with any number of mixers such that some embodiments include three or more mixers. Also, as explained further below, clock frequency signals f_{c1}, f_{c2}, and f_{c3} may or may not be derived from a common clock according to embodiments of the invention.

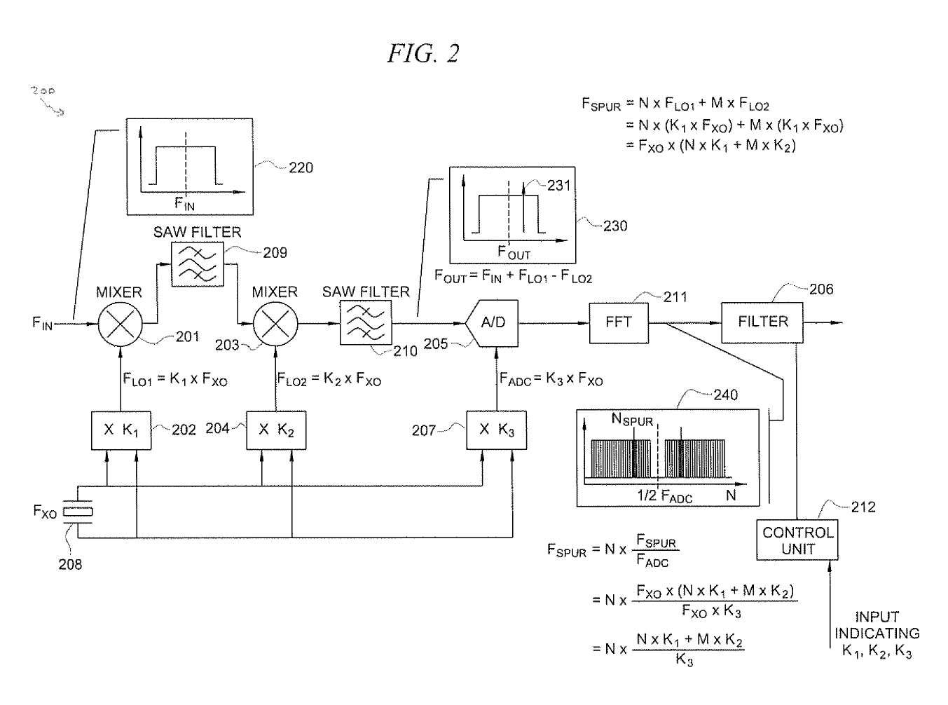

FIG. 2 is an illustration of exemplary system 200 adapted according to one embodiment of the invention. System 200 conforms to the basic architecture of system 100 (FIG. 1), but shows more details of one possible embodiment.

System 200 call generally be described as a dual-conversion tuner with a filtered, digital output that is fed to a downstream demodulation unit (not shown). System 200 also includes a particular clocking technique. Crystal oscillator 208 produces a signal of frequency fₓ₀, and the signal is shared by mixers 201 and 203 and ADC 205. In this example, mixers 201 and 203 are controlled by LOs 202 and 204, respectively, and the frequencies output by LOs 202 and 204 are denoted by factors “k”, which represent constants that are multiplied by fₓ₀ to produce the respective LO frequencies. The factors “k” do not necessarily have to be integers. The sampling frequency of ADC 205 is controlled by frequency unit 207 that also applies a multiplication factor to frequency fₓ₀. Frequency unit 207, in some examples, can be implemented by using a frequency multiplier a frequency divider, and/or other frequency-changing components.

The signal input to mixer 201 has a frequency spectrum represented by fᵢₙ and illustrated in graph 220. The signal input to mixer 201 may be received from an RF filter (not shown) or other source. Mixer 201 “up converts” the signal, passes the signal to Surface Acoustic Wave (SAW) filter 209, which filters the first IF signal. (Any kind of filter can be used for filters 209 and 210, as a SAW filter is only one example. In fact, many of the details shown in system 200 may be changed or omitted in alternative embodiments.) The filtered first IF signal is passed to mixer 203, which “down coverts” the signal. SAW filter 210 then receives the signal, and the result is an output IF signal with a frequency spectrum fₒᵤₜ. The IF signal frequency is shown in graph 230, where arrow 231 represents a spur.

For a dual-conversion tuner (e.g., as in system 200), the LOs will typically cause spurs, the frequencies of which are given by equation (1), wherein “n” and “m” are integer indices (positive, negative, and/or zero) that can be used to identify a particular spur.

ƒ_{SPUR}=n×ƒ_{LO1}−m×ƒ_{LO2} (1)

Thus, the spurs are based on harmonics of the LO frequencies. In any given system, some spurs will have more power than others and, thus, will be of more concern for designers. Also, some spurs may lie in an intended output spectrum while other spurs lie outside of the output spectrum. In most systems, spurs outside of the intended output spectrum are simply disregarded, e.g, they are typically removed or mitigated by an output filter, such as filter 210. However, it may be desirable to suppress one or more spurs that lie in the intended output spectrum before such spurs are sent to a downstream demodulator.

Various ways of calculating which spurs lie in the intended output spectrum may be used with some embodiments of the invention. One such technique is mapping fₒᵤₜ and various spurs within a range of indices and noting the indices of spurs that lie in the output spectrum. (For most systems, the range of indices can be limited to negative ten to ten; however, such range may be adapted according to the features of a system and the goals of its designers.) Rather than calculate every harmonic and check that each calculated harmonic does not fall within the determined band or bands, one technique determines the smallest harmonics that are greater than each edge of the intended output band. For an interfering spur, a difference of the LO harmonics falling within the intended output band may be determined to exist where the smallest harmonic difference for a particular LO harmonic that is greater than a first edge of a determined band is not equal to the smallest harmonic difference for the particular LO harmonic that is greater than a second edge of the determined band. Such a technique is described in U.S. patent application Ser. No. 11/325,854.

The IF output signal is then sent to ADC 205, which converts the signal to a digital signal using a sampling frequency that is based upon fₓ₀. The digital IF signal is then sent to Fast Fourier Transform (FFT) unit 211, which converts the information in the signal into a frequency domain representation thereof. Any kind of frequency domain transformation can be used in a variety of embodiments, such as Z-transforms, Discrete Fourier Transforms (DFTs) and the like. The output of FFT unit 211 is a number of frequency “bins”—discrete sets of data that each describe the signal at a particular frequency. A given FFT can be said to have “N” bins, and N is usually a power of two, e.g., 2,048 frequency bins. Two frequency bins containing a spur are shown in graph 240.

Since the ratios of the frequencies of the clock signals are known and are, in effect, “rolled into” the k factors discussed above, a relation can be used to identify the particular bin or bins that include the spurs of interest, referred to herein as “Nₛₚᵤᵣ.” This is especially convenient in a system wherein the clock frequencies are based off of the same base clock or crystal, since the “k”s are given from units 202, 204, and 207, rather than in a system wherein the “k”s are calculated. The relation is derived as follows:

f_{spur is a function of the LO harmonics: ƒ}ₛₚᵤᵣ=n×ƒ_{LO1}−mƒ_{LO2}

Therefore, fₛₚᵤᵣ can be simplified:

$$\begin{matrix}{f}_{spur} = n \times ( {k}_{1} \times {f}_{X 0} ) - m ( {k}_{2} \times {f}_{X 0} ) \\ = ( n \times {k}_{1} - m \times {k}_{2} ) \times {f}_{X 0} \\ = a \times {f}_{X0}\end{matrix} \qquad ( 2 )$$

Also, ƒ_{ADC}=k₃×ƒ_{X0}.
Accordingly, the bin number for a given spur is found as follows, where “N” is the size of the FFT:

$${N}_{spur} = N \times \frac{{f}_{spur}}{{f}_{ADC}} = N \times \frac{a \times {f}_{X 0}}{{k}_{3} \times {f}_{X 0}} = N \times \frac{a}{{k}_{3}} . \qquad$$

Thus, the relation for finding a bin number for a spur (Nₛₚᵤᵣ) is given by equation (2).

$${N}_{spur} = N \times \frac{a}{{k}_{3}} \qquad ( 3 )$$

In this example, control unit 212 calculates the spurs, finds indices of spurs which lie in the Output spectrum of interest, calculates bins for at least some of those spurs, and applies an appropriate filter to suppress the spurs in the spectrum of interest, Control unit 212 instructs filter unit 206 to apply a notch filter to suppress (e.g., “zero-out” or otherwise reduce) the bins that contain the spur or spurs of interest. Thus, the notch filter is based, at least in part, on the frequency ratios of the clock signals f_{c1}, f_{c2}, and f_{c3}. The result is that, in many cases, only those bins that contain the spur or spurs of interest are canceled, whereas other bins remain untouched. In other words, minimal filtering is applied to the signal. An error correction unit (not shown) can then reconstruct much of the information that was filtered out from the unfiltered information, according to embodiments.

There is no requirement that the LOs and the ADC be driven by the same clock. In facts various embodiments may suppress spurs as described above when the ratios of the clock signals are known, regardless of whether the clock signals are based on the same clock.

FIG. 3 is an illustration of exemplary system 300 adapted according to one embodiment of the invention. In system 300, one or more of f_{c1}, f_{c2}, and f_{c3} may be based upon a clock different from that of the others. Control system 301 measures the clock signals and calculates differences therebetween. For example, in one embodiment, control system 301 uses signal f_{c1} as a base and calculates the differences in f_{c2} and f_{c3} based thereon. The differences can be calculated as a factor multiplied by f_{c1}, so that the “k” for f_{c1} is one, and the “k”s for f_{c2} and f_{c3} reflect the differences in the signals. Equation (3) can then be used, as in the example described above, to cause filter unit 106 to suppress the bins that contain Spurs of interest.

FIG. 4 is an illustration of exemplary method 400 adapted according to one embodiment of the present invention. Method 400 may be performed, for example, by a control unit, such as unit 212 (FIG. 2). A control unit performing a method according to the present invention may be hardware-based, software-based, or a combination of both. In software and/or firmware implementations, the functionality lies in computer-readable code, which when executed, causes one or more components to perform the operations.

Method 400, in this example, is performed in a tuning system that includes a plurality of mixers, each of the mixers controlled by a local oscillator, and an analog-to-digital converter (ADC), wherein each of the local oscillators and the ADC are driven with respective clock signals. The mixers may be included in a dual-conversion tuner with two mixers, a triple-conversion tuner with three mixers, a quadruple-conversion mixer: etcetera. In some embodiments, the tuner is at least partly formed on a semiconductor chip, such that the mixers are formed of Complementary Metal Oxide Semiconductor (CMOS), SiGe, or other semiconductor logic. In step 401 each of the local oscillators and the ADC are driven with respective clock signals. The clock signals may be based on the same clock or may be from different clocks.

In step 402, frequencies for one or more spurious signals in an output band of interest are calculated. Step 402 may include mapping at least a subset of possible LO-related spurs and determining which of those spurs lie in the output band of interest. Other techniques are possible in some embodiments. In fact, any technique that allows for determining frequencies of spurs in an output band of interest may be used in one or more embodiments of the invention. In some embodiments, step 402 includes identifying such spurs by indices, the indices representing the mixed harmonics that cause the LO-related spurs.

In step 403, a notch filter is generated based at least in part on frequency multiplication factors in each of the clock signals. In some embodiments, step 403 includes performing an FFT operation on the digital data from the ADC to change the data into a frequency domain representation. Then it is determined which of the FFT bins contain the spurs in the output band of interest. An example way to determine which of the bins contains the output band of interest is to use a relation, such as equation (3), which can take the indices of the spurs of interest and multiplication factors for each of the respective clock signals as input and produce an indication of the particular bins that contain the spurs of interest. In such embodiments, the filter is based, at least in part, on weighted frequency ratios between the clock signals, since the magnitudes of the multiplication factors at least partly determine the bin numbers.

In step 404, the notch filter is applied to a digital signal output of the ADC, thereby suppressing the one or more spurs in the output band of interest. In one embodiment, the filter suppresses the bins that are determined to contain the spurs in the output band of interest. Step 404 may also include applying error-correction logic to the output of the filter to restore signal information that is removed by the filter, thereby restoring the signal while suppressing the spurs.

While method 400 is shown as a series of steps, various embodiments of the invention are not so limited. In fact, some embodiments may add steps, delete steps, and/or perform some steps out of order from that shown in FIG. 4. For example, in some embodiments, step 401 is performed continuously such that it occurs before, during, and after steps 402-404. Further, some embodiments may repeat the process, e.g., when channels are changed by a user. In such a case, the frequencies of LOs that drive the mixers may be reset to new values, and the spurs and notch filter may be recalculated.

Various embodiments are not limited to using the filter described in the above examples. In fact, any notch filter, now know or later developed, may be used in various embodiments. For instance, in some embodiments, steps 403 and 404 are performed by generating and applying a multiple-tap Finite Impulse Response (FIR) filter in addition to or alternatively to the FFT filter described in the examples above. In such an example, the indices of the spurs in the spectrum of interest can be calculated, as in the examples above. Then, the indices may be used to calculate coefficients for the FIR filter that cause the FIR filter to effectively suppress those spurs. Of course, calculating coefficients from spur indices will, in many embodiments, depend upon the specifics of the FIR filter. In such a case, generating a notch filter does not necessarily include generating the FIR filter entirely “from scratch” as it may include as little as generating the coefficients for an already-existing hardware- or software-based FIR filter.

Various embodiments of the present invention may be used in combination with other spur-minimizing techniques. A technique described in U.S. patent application Ser. No. 10/952,185 shifts the frequency of the IF signal so that it does not include possible spurs. However in some instances, a scenario may exist wherein the IF frequency cannot be shifted to eliminate all local-oscillator-related spurs in the intended output spectrum. Spur suppression according to embodiments of the present invention may be used to suppress spurs that cannot be avoided in such systems.

Various embodiments of the invention may be used in a wide range of applications. For instance, tuning systems that suppress spurs as described above may be included in television sets, digital video recorders, laptop computers, and other devices that receive RF signals. A particular application that is well-suited to some embodiments is a cable-modem that conforms to the Data Over Cable Service Interface Specification (DOCSIS) standard. New versions of DOCSIS require tuning large spectrums at once (e.g, up to and exceeding 80 MHz). Larger spectrums typically include more spurs, both LO-related and otherwise, than do narrower spectrums. In such systems, it may be advantageous to suppress as many spurs in the output band of interest as possible. For example, more spurs may cause scenarios wherein there is no LO-tuning that can avoid all spurs. Thus, suppression according to the description above may be used to eliminate one or more spurs thereby facilitating avoidance.

It should be noted that a shared crystal frequency signal is more conveniently implemented in an integrated design. For instance, some embodiments may dispose the mixers, LOs, and an ADC on a same semiconductor chip. In such a case, a common crystal frequency signal can be routed to the various components within the chip. However, some embodiments are not limited to chip-based systems, as long as the respective clock frequencies and the relationships therebetween can be calculated with enough precision to allow for suppression of individual units of data in a frequency domain representation of the signal.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A system for processing a signal, said system comprising:
a tuner with a signal path that includes two or more mixers, each of said mixers controlled by a respective local oscillator (LO);
an analog-to-digital converter (ADC) in said signal path operable to produce a digital signal, wherein each of said local oscillators and said ADC are driven by clock signals; and
a filter unit adapted to apply a notch filter to one or more spurious signals in said digital signal, wherein said notch filter is based at least in pan on frequency multiplication factors in each of said clock signals.

2. The system of claim 1 further comprising a common oscillating signal, wherein said clock signals are produced from said common oscillating signal.

3. The system of claim 1 further comprising a plurality of oscillating signals, wherein said clock signals are produced from said plurality of oscillating signals, and differences between frequencies of said oscillating signals are known.

4. The system of claim 1 wherein said spurious signals are caused by said local oscillators.

5. The system of claim 1 wherein the number of mixers is two, and said spurious signals are described by the relation;
ƒ_{SPUR}=n×ƒ₁−m×ƒ₂
wherein n and m are both integers, f₁ is a frequency of a first of said local oscillators, and f₂ is a frequency of a second of said local oscillators.

6. The system of claim 1 wherein said filter unit is further adapted to determine an output band of interest for the tuner and identify that said spurious signals are within said output band of interest.

7. The system of claim 1 wherein said fitter unit is adapted to transform data in said digital signal into a frequency domain representation, to specifically identify discrete data units in said frequency domain representation containing said spurious signals, and to suppress said spurious signals based on the identifying.

8. The system of claim 1 wherein said tuner comprises:
a Radio Frequency (RF) filter at an input thereof;
a first and a second mixer, each controlled by a first and second LO, respectively, and wherein said first mixer is adapted to receive a signal from said RF filter;
a first Intermediate Frequency (IF) filter between said first and second mixer adapted to output a first IF signal; and
a second IF filter after said second mixer adapted to produce an output IF signal that is sent to said ADC, wherein said tuner and said ADC are disposed, at least partially, on a same semiconductor chip.

9. The system of claim 1 further comprising:
error correction logic adapted to restore said filtered digital signal.

10. A system for processing a signal, said system comprising:
a tuner with a signal path that includes two or more mixers, each of said mixers controlled by a respective local oscillator (LO);
an analog-to-digital converter (ADC) in said signal path adapted to receive an Intermediate Frequency (IF) signal from one of said mixers and to produce a digital signal therefrom, wherein clock signals drive said ADC and each of said local oscillators; and
a filter unit adapted to apply a notch filter to one or more spurious signals in said digital signal, wherein said spurious signals are functions of particular harmonics of said clock signals driving said oscillators.

11. The system of claim 10 wherein said notch filter is based at least in part on frequency ratios between said clock signals.

12. The system of claim 10 wherein the number of mixers is two, and said spurious signals are described by the relation:
ƒ_{SPUR}=n×ƒ₁−m×ƒ₂
wherein n and m are both integers, f₁ is a frequency of a first of said local oscillators, and f₂ is a frequency of a second of said local oscillators.

13. The system of claim 10 wherein said tuner comprises:
a Radio Frequency (Max) filter at an input thereof;
a first and a second mixer, each controlled by a first and second LO, respectively, and wherein said first mixer is adapted to receive a signal from said RF filter;
a first Intermediate Frequency (IF) filter between said first and second mixer adapted to output a first IF signal; and
a second IF filter after said second mixer adapted to produce said IF signal and to send said IF signal to said ADC, wherein said tuner and said ADC are disposed, at least partially, on a same semiconductor chip.

14. The system of claim 10 further comprising a common crystal oscillator, wherein said clock signals are produced from said common crystal oscillator.

15. The system of claim 10 further comprising a plurality of oscillating signals, wherein said clock signals are produced from said plurality of oscillating signals, and differences between frequencies of said oscillating signals are known.

16. The system of claim 10 wherein said filter unit is adapted to perform a Fast Fourier Transform (FFT) operation on said digital signal to produce a frequency domain representation thereof to specifically determine one or more discrete data portions of said frequency domain representation that contain said one or more spurious signals, and to suppress said one or more discrete data portions.

17. A method for processing a signal, said method comprising:
in a tuning system that includes a plurality of mixers, each of the mixers controlled by a local oscillator, and an analog-to-digital converter (ADC), driving each of the local oscillators and the ADC with respective clock signals;
calculating frequencies for one or more spurious signals in an output band of interest;
generating a notch filter based at least in part on frequency ratios bewveen said clock signals; and
applying said notch filter to a digital signal output of said ADC thereby suppressing said one or more spurious signals.

18. The method of claim 17 wherein said respective clock signals are based upon a common clock signal.

19. The method of claim 17 further comprising:
calculating differences between two or more oscillating signals upon which said respective clock signals are based; and
calculating said frequency ratios from said differences.

20. The method of claim 17 wherein applying said notch filter comprises;
performing a frequency domain transformation on said digital signal output of said ADC, the output of which is a plurality of discrete data units, each of the data units representing a frequency of said digital signal output of said ADC;
specifically identifying one or more of said data units that correspond to frequencies of said spurious signals; and
suppressing said one or more identified data units.

21. The method of claim 17 wherein said notch filter includes a Finite Impulse Response (FIR) filter, and wherein said generating a notch filter comprises:
calculating a plurality of coefficients for said FIR filter that cause said FIR filter to effectively suppress said one or more spurious signals in the output band of interest.

22. A method for processing a signal, said method comprising:
in a tuning system that includes a plurality of mixers, each of the mixers controlled by a local oscillator, and an analog-to-digital converter (ADC), driving each of the local oscillators and the ADC with respective clock signals;
calculating a frequency of a spurious signal in an output band of interest;
performing a frequency domain transformation on said digital signal output of said ADC, the output of which is a plurality of discrete data units, each of the data units representing a frequency of said digital signal output of said ADC;
specifically identifying at least one data unit that corresponds to said spurious signal, using frequency multiplication factors in each of said clock signals; and
suppressing said identified at least one data unit.

23. The method of claim 22 wherein said tuning system is included in one of the following devices:
a television set;
a personal computer; and
a Data Over Cable Service Interface Specification (DOCSIS) modem.
